(19) United States
(12) Patent Application Publication
(10) Pub. No.: US 2006/0265662 A1
(43) Pub. Date: Nov. 23, 2006

(54) System and method for generating and updating user interfaces of web-based applications

(75) Inventor: Joshua J. Gertzen, Plano, TX (US)

Correspondence Address: BAKER BOTTS L.L.P., 2001 ROSS AVENUE, SUITE 600, DALLAS, TX, 75201-2980, US

(73) Assignee: Custom Credit Systems, L.P.

(21) Appl. No.: 11/133,910

(22) Filed: May 19, 2005

(51) Int. Cl. G06F 9/00

(52) U.S. Cl. 715/760

(57) ABSTRACT

A method for generating and updating a graphical user interface (GUI) includes receiving, at a web server, a request for a web-based application from a web client. The method further includes communicating an initial web page to the web client including instructions for generating a GUI for the application that includes one or more components and communicating support scripts to the web client. In addition, the method includes receiving one or more action events from the web client at the web server indicating one or more user actions associated with the GUI that have occurred at the web client. Furthermore, the method includes generating one or more update events at the web sever based on the received action events and communicating the update events to the web client. The update events instruct the web client to call one or more of the support scripts to update one or more components of the GUI in response to the user actions.

### TECHNICAL FIELD

This disclosure relates generally to the field of web-based applications and more specifically to a system and method for generating and updating user interfaces of web-based applications.

### BACKGROUND

The World Wide Web (the “web”) has allowed companies and other entities to provide publicly-accessible web sites to market their products and services and to interact with customers. Furthermore, many companies have used the ease of deployment, centralized management, and high availability that web applications provide to maintain internal business process applications built using web-based technologies. However, the transition of such applications to a web-based environment has created a number of challenges to application developers that did not exist under desktop application development frameworks that were previously used to implement these applications.

In a web-based environment, users frequently view information or other data using a browser providing a graphical user interface (GUI). Numerous web server frameworks have been developed to perform dynamic generation of GUIs for presentation to a user via a browser. All of these frameworks fundamentally work using the same concept—the request/response model. In this model, a Hypertext Transport Protocol (HTTP) request is received by a web server from a web client (usually a web browser) and an HTTP response is generated by the server and returned to the client. In the case of a web browser this response is typically Hypertext Markup Language (HTML) content that is rendered as a web page.

The request/response model utilized by these frameworks requires the logic flow of a web-based application to be built in a fragmented manner. In most cases, each client request goes to a specific request handler on the server (for example, a specific Active Server Page (ASP) or PHP Hypertext Preprocessor (PHP) page on the server) and that request handler is designed to respond exclusively to that request, typically by generating HTML to send as the response. While this fragmented approach works adequately for certain types of web content, it often fails to adequately address the needs of an application that requires a specific, connected flow of logic and significant state information to exist across multiple requests from a web client. Some frameworks have been developed to persist state information across multiple requests in a request/response model, but the vast majority of the frameworks do not address the fragmented logic issue. Those frameworks that do address this issue still require the application developer to program according to the request/response model, which often creates unneeded complexity and can limit the capabilities of a web-based application.

### SUMMARY

A system and method for generating and updating user interfaces of web-based applications are provided. According to one embodiment, a method for generating and updating a graphical user interface (GUI) includes receiving, at a web server, a request for a web-based application from a web client. The method further includes communicating an initial web page to the web client including instructions for generating a GUI for the application that includes one or more components and communicating support scripts to the web client. In addition, the method includes receiving one or more action events from the web client at the web server indicating one or more user actions associated with the GUI that have occurred at the web client. Furthermore, the method includes generating one or more update events at the web sever based on the received action events and communicating the update events to the web client. The update events instruct the web client to call one or more of the support scripts to update one or more components of the GUI in response to the user actions.

Technical advantages of certain embodiments of the present invention may include a process for developing web-based applications using a desktop application development model to provide GUIs with complex user interface components that are beyond those provided by the standard set of HTML form controls. As examples only, GUIs generated using particular embodiments may include GUI components such as a tree, a menu, a table, a tab folder, combo boxes, and multi-column drop-down menus. Additionally, such GUIs may include features that are not provided by HTML forms, such as text field edit masks and text area length limits. Furthermore, these GUI components are generated in certain embodiments using server-side programming libraries that provide the ability to respond immediately to various events a user may trigger in a GUI, such as focus, selection change, button click, and the like. Therefore, such GUIs provide interactive and low-latency response to user actions.

In addition, the desktop application development model used by particular embodiments may be used to create web-based applications that have flow control and logic that executes on a web server in a “top-down” fashion in the same way that a desktop application handles logic (typically with only one entry point). This top-down execution enables server-side web applications to interact with a user at a web client to update a GUI based on a user's actions and to return to the server-side application logic to continue where it left off before the update.

Furthermore, the desktop application development model used by certain embodiments allows the application state to be stored in variables at various levels of scope, much in the same manner that an application's state is tracked when developing a desktop application. This is unlike applications based on the request/response model that requires state to be maintained using a special mechanism.

Additionally, particular embodiments of the present invention define a process for constructing web-based applications and associated GUIs using the programming language of the server-side development environment and provide programming libraries implementing this process. This eliminates the need for the developer to be familiar with HTML, Cascading Style Sheets (CSS), the Document Object Model (DOM), client-side JavaScript, browser specific object models or any other web programming tools required to construct a web application using previous techniques. Furthermore, unlike HTML & CSS (which approach the layout of a web page from a desktop publishing standpoint), particular embodiments of the present invention provide an application development framework like the desktop development model (which, as a simple example, would set the x, y, width and height properties of a component in order to place it on the screen).

It will be understood that the various embodiments of the present invention may include some, all, or none of the enumerated technical advantages. In addition other technical advantages of the present invention may be readily apparent to one skilled in the art from the figures, description, and claims included herein.

### BRIEF DESCRIPTION OF THE DRAWINGS

For a more complete understanding of the present disclosure and its advantages, reference is now made to the following descriptions, taken in conjunction with the accompanying drawings, in which:

FIG. 1 illustrates an example system for generating and updating graphical user interfaces (GUIs) according to one embodiment of the present invention;

FIG. 2 illustrates an example GUI and updates the GUI based on user actions in the GUI; and

FIG. 3 is a flowchart illustrating an example method for generating and updating a GUI.

### DETAILED DESCRIPTION OF THE DRAWINGS

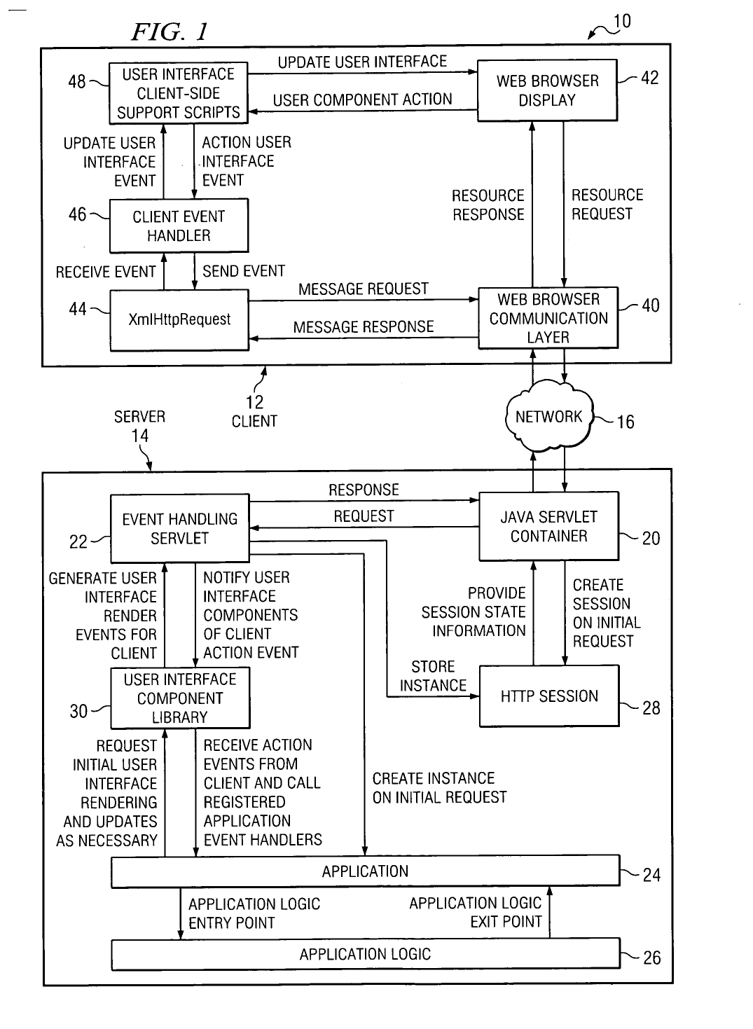

FIG. 1 illustrates an example communication system 10 for generating and updating graphical user interfaces according to one embodiment of the present invention. Communication system 10 includes one or more clients 12 and one or more web servers 14 coupled via a network 16. In general, communication system 10 enables a client 12 to request from the server 14 one or more graphical user interface (GUI) elements associated with a web-based application at the server 14, enables the server 14 to communicate information to the client 12 to generate such GUI elements, and enables the client 12 and the server 14 to dynamically and incrementally update the GUI elements on the client 12 based on continuing input from a user of the client 12. In short, as described in further detail below, system 10 provides an event-driven framework for constructing distributed, web-based applications that are created and operate in a similar manner as desktop applications. Such web-based applications created and executed using system 10 automatically maintain state with the client 12 with which the user of the application is associated, maintain a hierarchical flow of application logic on the server 14, provide application developers a consolidated, abstracted syntax for generating GUIs, and provide users of the applications with a rich, dynamic GUIs.

Each client 12 may include input devices, output devices, mass storage media, processors, memory, interfaces, communication ports, or other appropriate components for communicating requests to the server 14 and for viewing or processing the information communicated from the server 14, as described in further detail below. Client 12 may be implemented as a personal computer, workstation, video-conferencing equipment, a wireline or wireless communication devices, a personal digital assistant (PDA), or any other suitable device or application. Client 12 may include the typical, well-known components of a web browser. In the example of FIG. 1, the client 12 includes a web browser communication layer 40 that handles communications with the server 14 over the network 16. Browser communication layer 40 may be of the type commonly used in conventional web browsers, such as Microsoft's Internet Explorer. Similarly, the client 12 also includes a web browser display 42 that handles the actual rendering of GUIs and other content for display to a user and which may be of the type found in conventional web browsers. Additionally, client may include an “XmlHttpRequest” component 44 (included with most conventional web browsers) that allows client-side script, typically JavaScript, to send and receive HTTP messages to and from the server 14 though the browser communication layer 40.

Although one client 12 is illustrated, the present disclosure contemplates system 10 including any suitable number of clients 12, according to particular needs. Each client 12 may submit one or more requests to the server 14 to provide one or more GUI elements for display at the client 12. The GUI elements may include one or more text boxes, one or more drop-down boxes, one or more check boxes, one or more radio buttons, one or more titles, one or more charts, and/or any other suitable GUI elements according to particular needs. In certain embodiments, the GUI elements may include elements of a HyperText Markup Language (HTML) form that includes scripts, styles, and other components, as described further below. Although GUI elements are referred to primarily as “elements,” the GUI elements may include GUI fragments, GUI components, or any other suitable subdivisions of a GUI.

It should be understood that “client 12” and “user” of client 12 may be used interchangeably without departing from the scope of this disclosure. As an example, the client 12 may comprise a computer that includes an input device, such as a keypad, touch screen, mouse, or other device that can accept information, and an output device that conveys information associated with the operation of the server 14, including digital data, visual information, or any other suitable information. Both the input device and output device may include fixed or removable storage media such as a magnetic computer disk, CD-ROM, or other suitable media to both receive input from and provide output to users of the client 12.

Server 14 may include any suitable server or other computer for storing and communicating information, such as GUIs, over network 16. This server may include one or more electronic computing devices operable to receive, transmit, process and store data associated with system 10. For example, the server 14 may include one or more general-purpose personal computers (PCs), workstations, server computers, or any other suitable devices. Such devices may include input devices, output devices, mass storage media, processors, memory, interfaces, communication ports, or other appropriate components. Server 14 may implement any suitable software for receiving requests for information from the client 12 and communicating that information over the network 16 to the client 12. In short, the server 14 may include any suitable software and/or hardware in any combination suitable to present the client 12 with one or more GUI elements as described below. Particular example software components of the embodiment of server 14 illustrated in FIG. 1 are described below in further detail.

Server 14 may include an interface for communicating with other computer systems, such as clients 12 over the network 16 in a client-server or other distributed environment. Network 16 facilitates wireless and/or wireline communication between the server 14 and clients 12. Network 16 may include one or more local area networks (LANs), radio access networks (RANs), metropolitan area networks (MANs), wide area networks (WANs), all or a portion of the global computer network known as the Internet, and/or any other network of wireline, optical, wireless, or other communication links. Information may be communicated over the network 16 using Internet Protocol (IP) packets, Frame Relay frames, Asynchronous Transfer Mode (ATM) cells, or any other suitable communication format. Server 14 may communicate with the client 12 via the network 16 using any suitable communication protocol. For example, in particular embodiments, the client 12 and the server 14 may communicate using HTTP.

Unlike typical communications between web servers and web clients, particular embodiments of the present invention maintain a persistent connection between the server 14 and the client 12 over the network 16. Such a persistent connection means that the client 12 may obtain information from the server 14 without having to submit a form to the server 14, as is typical with many web-based applications. Additionally, the sever 14 may directly notify the client 12 of any changes that need to occur within the GUI. Java applets, inline frames (iframes), XML HTTP requests, ActiveX controls, and/or any other suitable mechanisms may be used to provide this persistent connection.

Referring to the particular embodiment illustrated in FIG. 1, the server 14 includes a Java servlet container 20 that provides functionality to receive requests from and send responses to the client 12 using HTTP. Servlet container 20 also provides support for pluggable request handlers (“servlets”) that can be configured to respond to requests from the client 12 for specific uniform resource locator (URL) addresses. Event handling servlet 22 is one such servlet. Server 14 also includes one or more applications 24 that are stored on or associated with the server 14. Each application 24 includes application logic 26 that is operable to construct, in cooperation with other components of the server 14 and the client 12, GUIs or other content to present to a user of the application 24 at the client 12.

To initiate the communication of a GUI or other information from the server 14, a user of the client 12 inputs a URL for a specific application 24 that resides on the server 14. In response to the input, the web browser communication layer 40 of the client 12 establishes a connection to the server 14 and sends an HTTP request to the Java servlet container 20 of the server 14. Java servlet container 20 receives the URL and analyzes it to determine the appropriate request handling servlet, which in this case is the event handling servlet 22. Java servlet container 20 then communicates a Request object that represents the HTTP request from the client 12. Java servlet container 20 also creates an HTTP session 28 after receiving the initial HTTP request.

Upon receiving the Request object, the event handling servlet 22 creates a new instance of the application 24 identified by the HTTP request and the Request object. The instance of the application 24 is then stored on the HTTP session 28 so that it may be retrieved later when action events from a specific client 12 are received. This new instance of the application 24 starts in a new thread, and this new instance in turn calls the entry point for the associated application logic 26. The application logic 26 uses commands from a user interface component library 30 to construct and present all aspects of a GUI that is presented to the user of the application 24 at the client 12. User interface component library 30 includes all of the commands necessary to execute appropriate support scripts 48 to construct and modify GUIs associated with the application 24 based on input from the user at the client 12. Therefore, a developer may develop a web-based application that generates rich GUIs using these commands and without having to know to use HTML, Cascading Style Sheets (CSS), the Document Object Model (DOM), client-side JavaScript, browser specific object models or any other web programming tools typically required to construct a web application. All of this “know-how” is pre-programmed into support scripts 48 that may be executed using commands from library 30.

Upon receiving an initial request from the client 12 and initiating a new instance of the appropriate application 24, the server 14 returns a simple “skeleton” HTML page that contains a single “DIV” tag in its body (which serves as the insertion point for dynamic updates to the GUI created using the HTML page, as described below), a “LINK” tag pointing to a Cascading Style Sheet (CSS) that contains the styles for GUI components, and a series of “SCRIPT” tags that instructs the client 12 to download from the server 14 and execute a client event handler 46 and user interface client-side support scripts 48 used to generate GUIs for display to the user of the client 12. The client event handler 46 is a counterpart to the event handling servlet 22 on the server 14 and receives requests from the server 14 and dispatches the requests to appropriate components of the client 12. The CSS serves as a universal style sheet that defines the “look” of all the GUI components displayed at the client 12 as a part of the application 24. Each of the GUI components are based on this style sheet.

Therefore, after sending an initial HTTP request to the server 14 for a particular application 24, the client 12 receives from the server 14 a simple web page framework, a number of support scripts 48, and instructions to execute particular ones of these support scripts 48 to create an initial GUI (or GUIs) for display to a user of the client 12. Therefore, the server 14 does not generate an HTML page that includes all the necessary HTML code to generate a GUI, but rather sends a skeleton HTML page with appropriate scripts that the client 12 may run itself to create the GUI. Furthermore, as is described below, once the user of the client 12 begins to interact with the GUI, the client 12 sends user interface “action events” to the server 14 to indicate the user's interaction with the web page (for example, the selection of particular items in the GUI). Based on these action events, the server 14 communicates further commands (“update events”) to the client 12 to execute particular support scripts 48 that cause the GUI to be updated incrementally at the client 12 based on the user's interactions with the GUI. This is unlike typical web-based client-sever interaction in which a client submits a new form to the server after one or more user interactions with the GUI and in which the server sends an entire new HTML page that is updated based on the user interactions.

Once executed by the initial HTML page received from the server 14, the client event handler 46 instantiates an XmlHttpRequest object 44 that is then instructed to make an asynchronous HTTP GET request. This GET request is communicated to the event handling servlet 22 for the application 24 via the browser communication layer 40 and the Java servlet container 20. Upon receiving this GET request, the servlet 22 will block (not return a response) until one or more update events for the application 24 are generated from the user interface component library 30 in response to one or more action events received from the client 12 (these commands are used to execute particular support scripts 48 at the client 12).

When a user triggers an action event by manipulating the GUI, for example by typing a value into a text field or selecting an option from a drop-down menu, the XmlHttpRequest object 46 is used to send an HTTP POST command containing the action event to the event handling servlet 22 on the server 14, at which time the application 24 is retrieved from the HTTP Session 28 and the appropriate GUI component of the application 24 is notified of the action event. The GUI component then calls/invokes any event listeners that have been attached to the component (the server 14 instantiates event listeners associated with the various components in the GUI and with user actions that may occur with respect to those components when the GUI is initially generated). Typically, the invocation of the event listeners will lead to one or more update events being sent back to the client event handler 46 to update the GUI displayed to the user at client 12 (these update events may include commands from interface component library 30 to execute particular support scripts 48). For example, a value being entered into a text field of the GUI by the user might result in an update event that causes other fields to be enabled or the selection of an item in a drop-down menu might result in an update event that causes items in another drop-down menu to be changed.

When an initial update event is generated, the servlet 22 will unblock and return a response, containing a series of function calls to be made using the support scripts 48, to the XmlHttpReqeust object 44. The XmlHttpReqeust object 44 then forwards the response to the client event handler 46, which in turn calls the functions defined in the response. These function calls result in dynamic updates to the Document Object Model (DOM) associated with the GUI being displayed and thus changes the GUI in the web browser display 42.

After an initial update event is received at the client 12, the entire process of using the XmlHttpRequest object 46 to make an asynchronous requests to the server 14 (in response to action events) and receive update events from the server 14 may repeat indefinitely until either the browser associated with the client 12 is closed or a special event is received from the server 14 signaling that the application instance has terminated.

It should be understood that although particular HTTP commands and particular web components (such as Java servlets and XmlHttpRequest objects) are described as being used by the server 14 and the client 12 to generate and update GUIs, any suitable commands and components providing similar functionality may be used and are within the scope of the present invention.

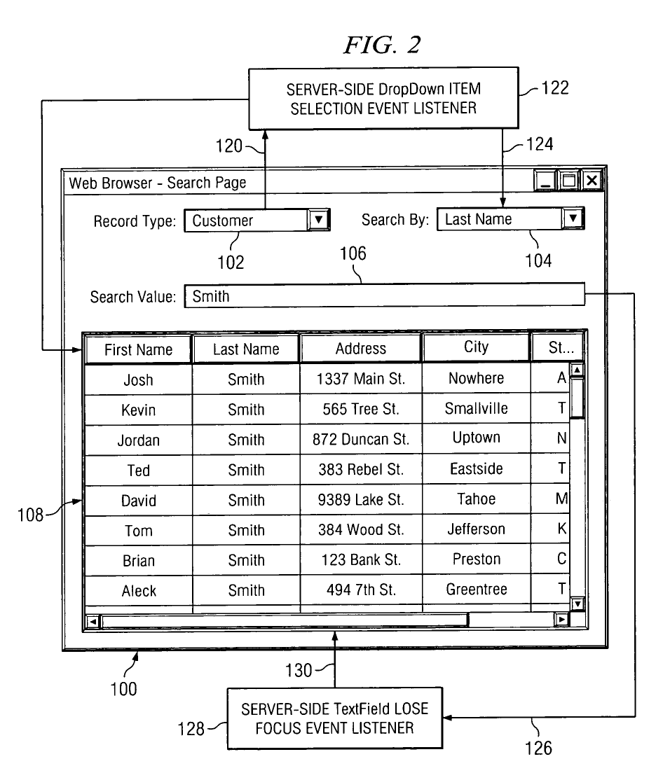

FIG. 2 illustrates an example GUI 100 generated by server 14 and client 12 and updated to the GUI 100 based on user actions in the GUI 100. As an example, GUI 100 is illustrated in an updated state after being initially generated at the client 12 based on the techniques described above and after some user interaction with GUI 100. FIG. 2 also illustrates particular steps involved in the process of updating the initial form of GUI 100 to its state as illustrated. As examples only, GUI 100 includes two drop-down menus 102 and 104, a text field 106, and a table component 108. Again as an example, these components may be used to perform a database search on a number of different record types that are stored in a database (for example, a database associated with server 14).

As an example of a typical use of GUI 100, the user may first select a record type to search in drop-down menu 102. Such a selection (in this example, the selection of the “customer” record type) is communicated as an action event to the server 14 (as indicated by arrow 120) and causes an item selection event listener 122 on the server 14 to be executed. The event listener 122 then queries a database to determine what fields for GUI 100 are valid for that record type and then causes appropriate update events to be sent back to the client 12 (as indicated by arrow 124). Based on these update events and using support scripts 48 associated with the update events, as described above, the client 12 would update the items contained in the “Search By” drop-down menu 104 and would update the columns displayed in the table 108. Again, this is different than typical web-based applications in which the user of the client would submit an updated form to the server after selecting the record type and the server would communicate an entire new GUI to the client that is updated to reflect the record type selection.

Upon the client 12 displaying the updated GUI 100, the user may then select a parameter to search by using the drop-down menu 104 (these parameters where added in the update based on the record type selection). The user may then enter a search value in the text field 106 and tab out of the field 106 or otherwise indicate the user is finished entering the search value. Upon tabbing out of the field 106, associated action events may be communicated to the server 14 (as indicated by arrow 126) and may cause a “lose focus” event listener 128 on the server 14 to be executed. The execution of the event listener 128 causes an associated database to be queried for records associated with the selection in the drop-down menu 104 that match the search value and causes update events to be sent back to the client 12 that would populate the table 108 with the search results (as indicated by arrow 130). In this manner, a GUI may be incrementally updated at the client 12 based on user actions (identified by action events) and corresponding update events communicated to and from the server 14. Although, a simple GUI 100 is presented with a limited number of user actions, it should evident that many more GUI components may be included in a GUI, many more user actions may be monitored to update the GUI, and many more dependencies of GUI components upon one another may be implemented.

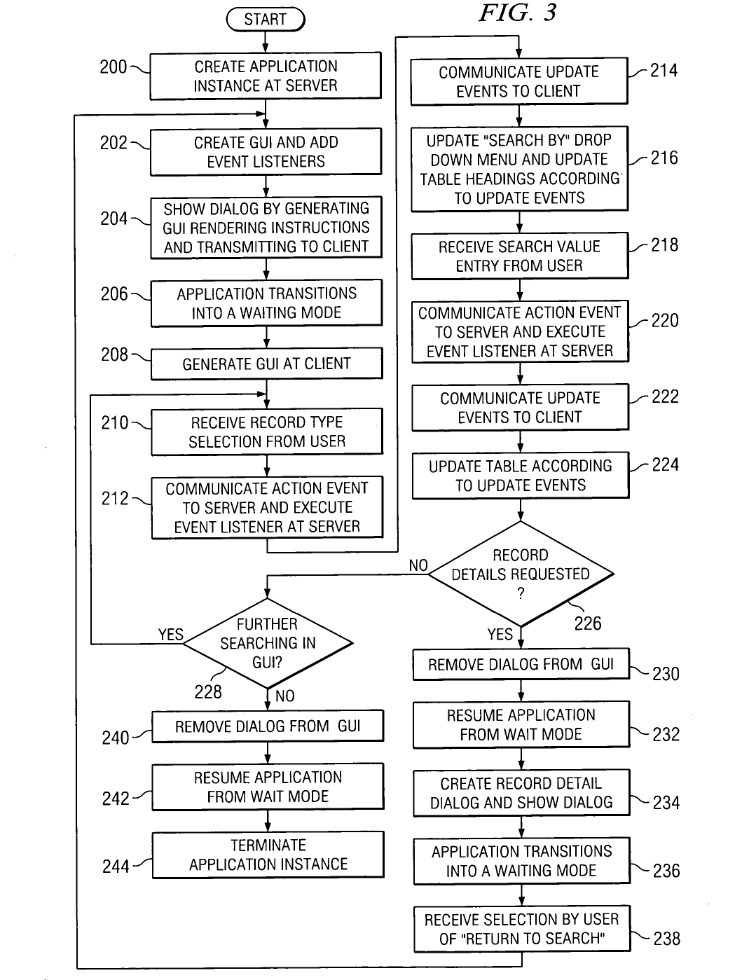

FIG. 3 is a flowchart illustrating an example method for generating a GUI. Specifically, this example method show the application logic, flow control, and state management for the generation and updating of GUI 100 and associated Guls, as described above in conjunction with FIG. 2. The method starts at step 200 where an application instance is created at the server 14 based on a request from the client 12. The request calls the entry point for an application 24, which in turn executes any application logic 26 that is to be executed prior to the GUI 100 being shown. At step 202, a new “dialog” window is instantiated and a number of GUI components are added to the dialog window instance to create the GUI 100. Furthermore, the server also associates one or more event listeners with the GUI components. At step 204, the newly constructed dialog is then shown to the user at the client 12 by generating GUI rendering instructions (referring to support scripts 48) and communicating these to the client. At step 206, the application instance at the server then transitions into a wait mode.

The client 12 generates the GUI 100 at step 208 based on the GUI rendering instructions. As described above in conjunction with FIG. 2, one of the actions the user may take in the GUI 100 is to select a record type to search using the “Record Type” drop-down menu. At step 210 of the example method, the client 12 receives such a record type selection from the user. At step 212, the client 12 communicates an action event to the server 14 indicating the record type selection and the server 14 executes an appropriate event listener associated with the record type GUI component. The server 14 then generates one or more update events based on the action event and communicates these update events to the client 12 at step 214. At step 216, the GUI 100 is updated at the client 12 based on the update events. For example, as described above, the “Search By” drop down menu and the table headings may be updated to reflect the record type selection. Furthermore, at step 218, the client 12 may receive a search value entry from the user. At step 220, the client 12 communicates an action event to the server 14 indicating the search value entry and the server 14 executes an appropriate event listener associated with this GUI component (as described above, this event listener may then initiate a database search to find records matching the entered search value). The server 14 then generates one or more update events based on the action event and communicates these update events to the client 12 at step 222. At step 224, the GUI 100 is updated at the client 12 based on the update events. For example, as described above, the table of the GUI 100 may be updated to show the matching database records.

Although not described in association with FIG. 2, this example method also provides a further option in GUI 100 for the user to select a particular record in the updated table to receive additional information related to that record. Therefore, at step 226, it is determined whether such additional details regarding a record are requested (for example, by the user clicking on the record entry in the table). If no such request is received, the example method proceeds to step 228. However, if such a request is received, the method proceeds to step 230. At step 230, the server 14 receives this request (as an action event) and removes the dialog (the dialog illustrated in FIG. 2) from the GUI. The application 24 then resumes from its waiting mode at step 234. Based on the received action event, the server 14 generates a new dialog used to show the details of the selected record (not illustrated) and shows this dialog (in a similar manner as described above for the “search” dialog). At step 236, the application 24 again transitions into a waiting mode. Such transitions to and from a waiting mode at the point at which the application entered the waiting mode show how the application flow is “top-down” and shows how the application can maintain state (since it returns to the point at which it was left after sending a dialog to the client 12 and updating that dialog). At step 238, in the example method, a selection may be received in the “record detail” dialog requesting a return to the search dialog. If so, the method may them return to step 202 and the method may repeat.

If record details are not requested at step 226, then the method continues at step 228 where it is determined whether the user desires to perform further searching in the GUI 100 (for example, the user may simply begin a new search by selecting a new record type, may select a “New Search” button (not illustrated), or take any other suitable action). If further searching is desired, the method returns to step 210. Alternatively, the method could also return to step 218. If no further searching is desired by the user at step 228, then the method may proceed to step 240 if the user instead indicates that the application should be terminated. In this case, the server 14 receives this request to terminate (as an action event) and removes the dialog from the GUI at step 240. The application 24 then resumes from its waiting mode at step 242 and the application instance is terminated at step 244.

Although a particular method for generating and updating a GUI has been described with reference to FIGS. 2 and 3, the present disclosure contemplates any suitable method for generating and updating a GUI in accordance with the present disclosure. Thus, certain of the steps described with reference to FIG. 2 or 3 may take place simultaneously and/or in a different order than as shown. Moreover, particular embodiments may use methods with additional steps, fewer steps, and/or different steps, so long as the methods remain appropriate. Furthermore, it should be understood that the GUIs described in FIGS. 2 and 3 are only examples, and that any of a large variety GUIs and GUI components may be generated and updated based on a large variety of user actions.

Moreover, in general, although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. A system for generating and updating a graphical user interface (GUI), comprising:
a web server comprising one or more components operable to:
receive a request for a web-based application from a web client;
communicate an initial web page to the web client including instructions for generating a GUI for the application, the GUI comprising one or more components; and
communicate a plurality of support scripts to the web client;
the web client comprising one or more components operable to:
generate the GUI based on the initial web page;
monitor user actions associated with the GUI; and
generate one or more action events indicating one or more user actions that have occurred at the web client;
wherein one or more components of the web server are further operable to:
receive the action events from the web client;
generate one or more update events based on the received action events; and
communicate the update events to the web client, the update events instructing the web client to call one or more of the support scripts to update one or more components of the GUI in response to the user actions.

2. The system of claim 1, wherein the request received from the web client comprises a Hypertext Transfer Protocol (HTTP) request identifying a Uniform Resource Locator (URL) associated with the application.

3. The system of claim 1, wherein the initial web page includes a tag indicating a position for insertion of updates to the GUI based on action events.

4. The system of claim 1, wherein the initial web page includes a tag identifying a style sheet to apply to the components of the GUI.

5. The system of claim 1, wherein the initial web page includes one or more tags instructing the web client to:
download from the web server a client event handler operable to communicate action events to the web server and to receive update events from the web server; and
download from the web server the plurality of support scripts.

6. The system of claim 5, wherein the client event handler is operable to call one or more of the support scripts in response to receiving one or more update events.

7. The system of claim 6, wherein calling the support scripts results in a Document Object Model associated with the GUI being updated to reflect one or more action events.

8. The system of claim 1, wherein the web server is further operable to instantiate one or more event listeners, each event listener associated with one or more components of the GUI.

9. The system of claim 8, wherein the web server is further operable to call one or more event listeners associated with a received action event, the event listeners operable to generate the one or more update events.

10. The system of claim 1, wherein the web-based application maintains state across a plurality of action events received by the web server from the web client.

11. A method for generating and updating a graphical user interface (GUI), comprising:
receiving, at a web server, a request for a web-based application from a web client;
communicating an initial web page to the web client including instructions for generating a GUI for the application, the GUI comprising one or more components;
communicating a plurality of support scripts to the web client;
receiving one or more action events from the web client at the web server indicating one or more user actions associated with the GUI that have occurred at the web client;
generating one or more update events at the web sever based on the received action events; and
communicating the update events to the web client, the update events instructing the web client to call one or more of the support scripts to update one or more components of the GUI in response to the user actions.

12. The method of claim 11, wherein the request received from the web client comprises a Hypertext Transfer Protocol (HTTP) request identifying a Uniform Resource Locator (URL) associated with the application.

13. The method of claim 11, wherein the initial web page includes a tag indicating a position for insertion of updates to the GUI based on action events.

14. The method of claim 11, wherein the initial web page includes a tag identifying a style sheet to apply to the components of the GUI.

15. The method of claim 11, wherein the initial web page includes one or more tags instructing the web client to:
download from the web server a client event handler operable to communicate action events to the web server and to receive update events from the web server; and
download from the web server the plurality of support scripts.

16. The method of claim 15, wherein the client event handler is operable to call one or more of the support scripts in response to receiving one or more update events.

17. The method of claim 16, wherein calling the support scripts results in a Document Object Model associated with the GUI being updated to reflect one or more action events.

18. The method of claim 11, further comprising instantiating one or more event listeners at the web server, each event listener associated with one or more components of the GUI.

19. The method of claim 18, further comprising calling one or more event listeners associated with a received action event, the event listeners operable to generate the one or more update events.

20. The method of claim 11, wherein the web-based application maintains state across a plurality of action events received by the web server from the web client.

21. Web server software for generating and updating a graphical user interface (GUI), the software being embodied in computer-readable media and when executed operable to:
receive a request for a web-based application from a web client;
communicate an initial web page to the web client including instructions for generating a GUI for the application, the GUI comprising one or more components;
communicate a plurality of support scripts to the web client;
receive one or more action events from the web client indicating one or more user actions associated with the GUI that have occurred at the web client;
generate one or more update events based on the received action events; and
communicate the update events to the web client, the update events instructing the web client to call one or more of the support scripts to update one or more components of the GUI in response to the user actions.

22. The software of claim 21, wherein the request received from the web client comprises a Hypertext Transfer Protocol (HTTP) request identifying a Uniform Resource Locator (URL) associated with the application.

23. The software of claim 21, wherein the initial web page includes a tag indicating a position for insertion of updates to the GUI based on action events.

24. The software of claim 21, wherein the initial web page includes a tag identifying a style sheet to apply to the components of the GUI.

25. The software of claim 21, wherein the initial web page includes one or more tags instructing the web client to:
download a client event handler operable to communicate action events to the web server software and to receive update events from the web server software; and
download the plurality of support scripts.

26. The software of claim 25, wherein the client event handler is operable to call one or more of the support scripts in response to receiving one or more update events.

27. The software of claim 26, wherein calling the support scripts results in a Document Object Model associated with the GUI being updated to reflect one or more action events.

28. The software of claim 21, further operable to instantiate one or more event listeners, each event listener associated with one or more components of the GUI.

29. The software of claim 28, further operable to call one or more event listeners associated with a received action event, the event listeners operable to generate the one or more update events.

30. The software of claim 21, further operable to maintain state using the web-based application across a plurality of action events received by the web server software from the web client.
